(19) United States
(12) Patent Application Publication
(10) Pub. No.: US 2009/0049527 A1
(43) Pub. Date: Feb. 19, 2009

(54) METHOD AND SYSTEM FOR EXCHANGING DATA RESERVED FOR A USER

(75) Inventors: Vincenzo Romeo, Rome (IT); Dominique Gauthier, Asnieres (FR)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: Compagnie Industrielle et Financiere D'Ingenierie "Ingenico", Neuilly Sur Seine (FR)

(21) Appl. No.: 12/032,264

(22) Filed: Feb. 15, 2008

(30) Foreign Application Priority Data
Feb. 15, 2007 (FR) 07/01100

(51) Int. Cl. G06F 21/00

(52) U.S. Cl. 726/4

(57) ABSTRACT

A method is provided to exchange data reserved for a user or a group of users with personal equipment. The method includes a step of short-distance communication of the data, for example of the NFC type, between the personal equipment and a secure terminal determined by an identification of the user and by a detection of the personal equipment in the vicinity of the secure terminal. The secure terminal preferably obtains the data from an integrated source by a secure end-to-end connection.

### CROSS-REFERENCE TO RELATED APPLICATIONS

None.

### FIELD OF THE DISCLOSURE

The field of the disclosure is that of secure electronic transactions in which data reserved for a user or a predetermined group of users is exchanged.

### BACKGROUND OF THE DISCLOSURE

An exchange of data reserved for a user involves, for example, data normally communicated in the context of a banking transaction: communication of amounts, contact information and codes for debiting an account. A set of data can also include one or more programs composed of instructions, parameters and variables for carrying out an application reserved for a user, for example, with the operation being related to a user profile or respecting the user's privacy. Data reserved for a user is not limited to that mentioned in the few examples here for purely illustrative purposes. It is also possible to cite the downloading of multimedia content or various computer files that cannot be used without the consent of the user to whom they belong.

Developments in electronics, information technology and telecommunications enable certain levels of performance and flexibility in terms of data exchanges.

For example, commercial transactions on the Internet are known, in which it is simply necessary to provide a credit card number in order to pay for the purchase of a product easily found on a rapidly accessible server. Telecommunications operators propose using a telephone, advantageously mobile, as identification means, relying, among other things, on the strong link that exists between the SIM card and the subscriber in order to secure sensitive data and uses of the subscriber. It is then possible to implement downloading mechanisms such as those of the OTA (Over-The-Air) type, owing to the infrastructure of the operator, in order to respond to the need to load the personal equipment constituted by the mobile telephone with the banking parameters of the user. There is a growing tendency to replace the SIM card with other components, such as a card in MMC (Multi Media Card) format, which integrates a smart card microcontroller, a card in SD (Secure Digital) format incorporating a ferroelectric memory suitable for contactless technology or another memory of this type, which the telephone operators see as super SIM cards with capacities approaching 1 Gb.

However, the known techniques are not entirely satisfactory. Indeed, one may hope for mobile telephones to be less sensitive to intrusions than computers connected to an open network. However, the agreements that must be entered into by reserved data managers, for example, banking institutions, each with operators, may involve problems of a commercial nature, as confidential information to be provided to the operators presents security problems. A source of dissatisfaction, particularly in terms of flexibility, also exists for the user who is strongly linked to his/her operator due to the fact that the latter directly or indirectly holds personal data.

### SUMMARY

An aspect of the disclosure relates to a method for exchanging data reserved for a user with personal equipment in order to overcome the disadvantages of the prior art. The method includes a step of short-distance communication of said data between the personal equipment and a secure terminal determined by an identification of said user and by a detection of said personal equipment in the vicinity of said secure terminal.

The secure terminal, for example a banking terminal thus acting as a data safe, makes it possible to eliminate the need for both the data manager and the user to go through a third party owing to the short-distance communication. This combination has numerous advantages, such as protecting the privacy and the integrity of the data exchanged. After being identified, the user can be sure that no one else is close enough to pick up on the short-distance communication.

In particular, the data exchange method includes a request step in which the secure terminal obtains said data from an integrated source by means of a secure end-to-end connection. This reinforces immunity to any malicious intrusions.

Also in particular, the data exchange method includes a step of invitation to bring the personal equipment close to the secure terminal. This provides the advantage of informing the user of a sensitive-phase start-up.

Not necessarily, but advantageously, when the integrated source is contained in a trusted server, or when the integrated source is in a smart card, a radiofrequency power is transmitted by the personal equipment in the short-distance communication step. For short-distance communications in which it is the receiver that transmits the power to enable the communication, as is the case in NFC (Near Field Communication) or transponder technologies, it enables the personal equipment to download data from the smart card inserted into the secure terminal, or from the server connected to the secure terminal. Thus, the secure terminal acts as a reliable data source through which the data coming from the smart card or the trusted server is routed.

The request step can be executed simultaneously to the invitation step, precede it, or follow it. It is beneficial to precede the invitation step by the request step so as to make the data immediately available when the personal equipment is brought near it, and thus reduce the time necessary for the data exchange.

An additional advantageous is provided by an integrated source contained in the personal equipment. A user wanting to dump his/her personal equipment so as to transfer, or not, the reserved data to other personal equipment can then bring his/her personal equipment to the secure terminal so as to transfer the data thereto before optionally bringing other personal equipment to it in order to continue the transfer, this time from the secure terminal. By personal equipment, we mean a mobile telephone or any other electronic device, such as an MP3 reader, a camera, a PDA, preferably on the condition that the device is secure.

In the short-distance communication step, a radiofrequency power transmitted by the secure terminal is particularly useful for personal equipment equipped with an NFC transmitter or a transponder.

The disclosure also relates to a system for exchanging data reserved for a user with personal equipment. The system includes a secure terminal arranged to carry out a short-distance communication with the personal equipment determined by a user identification and by a detection of the personal equipment in the vicinity of the secure terminal.

In particular, the secure terminal is arranged so as to obtain said data from an integrated source by means of a secure end-to-end connection and/or so as to display a message of invitation to bring the personal equipment to the secure terminal.

More specifically, the personal equipment is arranged so as to transmit a power by radiofrequency so as to carry out the short-distance communication by reading data provided on the terminal when the integrated source is contained in a trusted server or in a smart card placed in contact with the terminal.

Alternatively or simultaneously, the secure terminal is arranged to transmit a power by radiofrequency so as to carry out the short-distance communication by writing data into the personal equipment from the terminal when the integrated source is contained in a trusted server or in a smart card placed in contact with the terminal.

Also alternatively or simultaneously, the secure terminal is arranged to transmit a power by radiofrequency so as to carry out the short-distance communication by reading data provided on the personal equipment when the integrated source is contained in a the personal equipment or when the terminal is monitoring so as to detect the approach of personal equipment to which other information is to be transferred. In this last case, the data provided is, for example, simply data identifying the personal equipment.

### BRIEF DESCRIPTION OF THE DRAWINGS

Other features and advantages will appear on reading the following detailed description of embodiments, provided solely by way of example, and in reference to the appended drawings, which show:

FIG. 1, a diagrammatic view of a data exchange system in the context of the disclosure;

FIG. 2, method steps in a first embodiment of the disclosure;

FIG. 3, method steps in a second embodiment of the disclosure.

### DETAILED DESCRIPTION OF ILLUSTRATIVE EMBODIMENTS

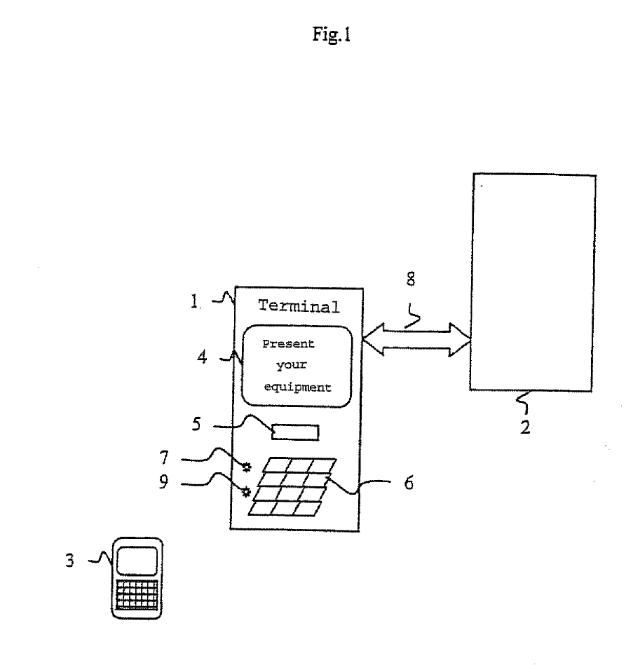

In reference to FIG. 1, a data exchange system for implementing an exemplary embodiment of the disclosure includes a secure terminal 1 arranged to carry out a short-distance communication with personal equipment 3.

As an example of a secure terminal 1, it is possible to cite a payment terminal under the control of an employee at a bank, and which is generally used when transmitting or renewing a payment card, a payment terminal in a store or an automatic cash dispenser as seen in bank entrances or in airports. What is important is that the terminal is secure, i.e. it is protected from intrusions and any breach attempt leaves clearly detectable traces.

The secure terminal 1 includes a screen 4 that makes it possible to display messages, such as a message shown here, inviting the personal equipment 3 to approach the secure terminal. The terminal also includes a slot 5 suitable for the insertion of a smart card or a card with a magnetic or holomagnetic strip, not shown, typically a credit card, or even a fidelity card, a travel pass, an identity card, a health card or a contactless card. In the last case, the slot is replaced by the appropriate reader. A keypad 6 then enables a user to authenticate or at least to identify him/herself by typing the secret code on the keypad 6 after having inserted his/her smart card into the slot 5, which in this case enables authentication. If a card is not inserted, a code that is generally longer than the four digits of the secret code then allows for simple identification, which may be enough, for example, to simply load a software update. Identification also results from the simple insertion of the smart card into the slot 5.

The secure terminal 1 includes a transmitter 7 for carrying out a short-distance communication. Unlike conventional transmitters, which transmit their information on a carrier for which they supply power, the short-distance communication transmitters generally transmit their information on a carrier of which the power is supplied by the receiver. This is the case, for example, of transponders in which the receiver covers a carrier generally at a low frequency with a small range and interprets information coming from the transmitter by detecting the variations in energy absorbed and/or reflected by the transmitter. The low-frequency transponders are essentially suitable for transfers of low-volume information, as a minimal number of alternations of the carrier is necessary for interpreting a variation in absorbed energy. In this sense, the short-distance communication receivers act as real readers in the standard sense, because they control the power for the reading of available information.

One beneficial short-distance communication technology is the NFC (Near Field Communication) technology. The frequency range is higher than in conventional transponders, within a range of 13.56 MHz, it allows speeds up to 424 Kbits/s. By comparison with another known technology, called Bluetooth, NFC technology has the advantage of a reduced size, contained on small chips suitable for being implemented in small electronic devices, and is therefore suitable for mobile telephones.

The short-distance communication transmitter 7 first makes it possible to detect personal equipment 3 brought into the vicinity when it is equipped with an associated receiver that covers the radiofrequency carrier.

The terminal 1 is arranged to then provide the transmitter 7 with the information, i.e. the data reserved for the user, during a fully predetermined time period, which barely exceeds the time necessary for communicating the data, in consideration of the exchange speed allowed by the short-distance communication. As the personal equipment 3 is arranged to transmit a power by radiofrequency, the short-distance communication results from the reading of the data provided to the transmitter 7.

In the data exchange system shown in FIG. 1, the secure terminal 1 is arranged to obtain the data reserved from an integrated source by means of a secure end-to-end connection.

When the integrated source is contained in a trusted server 2, for example a mainframe-type banking computer, the secure connection is typically a private connection 8 connecting the terminal 1 and the server 2 in an encrypted or physically controlled manner.

When the integrated source is contained in a smart card, the secure connection is typically an internal circuit arranged behind the slot 5 inside the terminal 1 and controlled by cryptographic exchange protocols and/or physical securements.

In an improved embodiment, the terminal 1 includes a receiver 9, constituted by technology similar to that of the transmitter 7. This makes it possible to take into consideration an integrated source that is contained in the personal equipment 3. With this device, the user does not need to contact his/her telephone operator when changing mobile telephones or when he/she prefers to load his/her reserved data into another device, such as, for example, an electronic device dedicated to an electronic wallet application.

With the receiver 9, as the secure terminal 1 is arranged to transmit a power by radiofrequency, the short-distance communication results from the reading of data provided by the personal equipment 3.

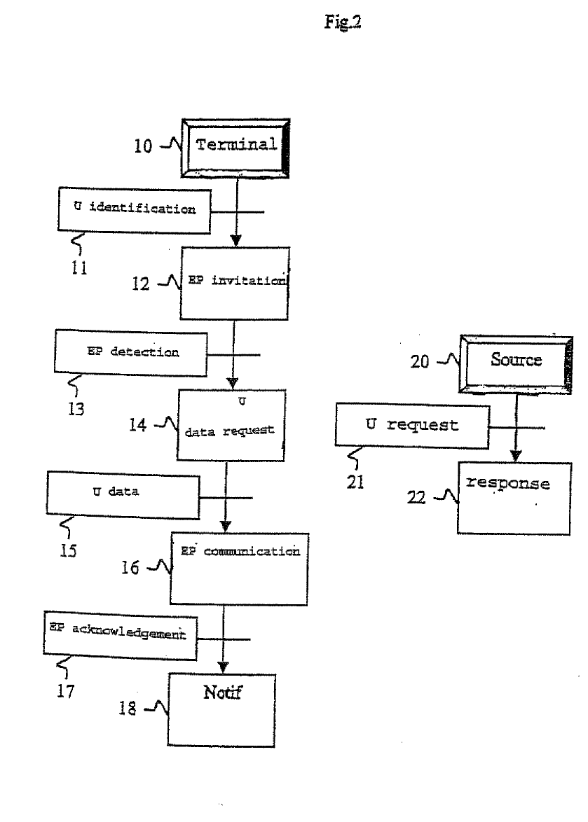

In reference to FIG. 2, we will now describe the steps of the method for exchanging data reserved for a user with personal equipment. It is preferable but not necessary for the method involving the steps described to be based on the system as described above in reference to FIG. 1.

The method uses a secure terminal, which is initially in a sleep step 10, activated to standby state when a personal equipment user appears.

A transition 11 is validated when the secure terminal detects a user identification. The identification is typically detected by recognition of a personal code that, when it conforms to a cryptographic smart card method, more precisely constitutes an authentication. The personal code may result from keystrokes on a keypad of the terminal, recognition of a fingerprint, a retinal scan, voice recognition or the like. A validation of the transition 11 when step 10 is activated causes step 10 to be deactivated and step 12 to be activated.

In step 12, the user is invited to bring his/her personal equipment to the terminal. The invitation can be made, in a non-limiting manner, by means of a display on the screen of the terminal or a voice message transmitted by a loudspeaker of the terminal. It is also possible in step 12 to give the user a choice on an integrated source, from which the reserved data is to be downloaded, for example a source contained in a remote trusted server, a source contained in a smart card or a source contained in the personal equipment itself. It is also possible in step 12 to provide a choice on the type of data to be downloaded, the values of the parameters related to a user profile, personal multimedia content or a sequence of instructions of a program to be installed, which choice may or may not determine an integrated source selection.

A transition 13 is validated when the secure terminal detects the personal equipment in the vicinity. The vicinity is typically but not necessarily detected by reception of a radio signal sent from the personal equipment. A validation of the transition 13 when step 12 is activated causes step 12 to be deactivated and step 14 to be activated.

In step 14, the terminal 11 transmits a request intended for the integrated source so as to obtain data reserved for the user. This request is transmitted on a secure connection, as allowed by an encrypted or a physically controlled connection, a cable connected to the secure terminal and to a computer acting as a server optionally via fully controlled automatic switches, a circuit inside the terminal itself for reading a smart card, or a short-distance communication connection.

A transition 21 is validated when the integrated source receives the request. A validation of the transition 21 when a step 20 is activated in an initial standby state of the integrated source causes step 20 to be deactivated and step 22 to be activated.

In step 22, the integrated source transmits a response intended for the secure terminal on the secure connection used to receive the request, or on a similar connection. The response contains the requested data.

A transition 15 is validated when the secure terminal obtains the data from the integrated source. A validation of the transition 15 when step 14 is activated causes step 14 to be deactivated and step 16 to be activated.

In step 16, a short-distance communication of data reserved for the user is executed between the personal equipment and the secure terminal. The data intended for the personal equipment is provided preferably during a limited time period, pending the reading by the personal equipment, which then transmits a radiofrequency power of which the attenuation or the reflection sequentially reflects the value of the data. The data originating from the personal equipment is read by the secure terminal by transmitting a radiofrequency power absorbed or reflected by the personal equipment matching the value of the data to be read.

A transition 17 is validated by acknowledgement of the short-distance communication, which indicates that all of the data to be transmitted has been successfully received by the recipient. A validation of the transition 17 when step 16 is activated causes step 16 to be deactivated and step 18 to be activated.

In step 18, the secure terminal indicates that the communication with the personal equipment has been successful. A notification to the user by means of a voice or visual message reassures the user of the success of the transaction. A notification to the trusted server or to the smart card makes it possible to record the communications carried out so as, for example, to check for any duplications or a date or even a location of an aborted or successful fraudulent attempt.

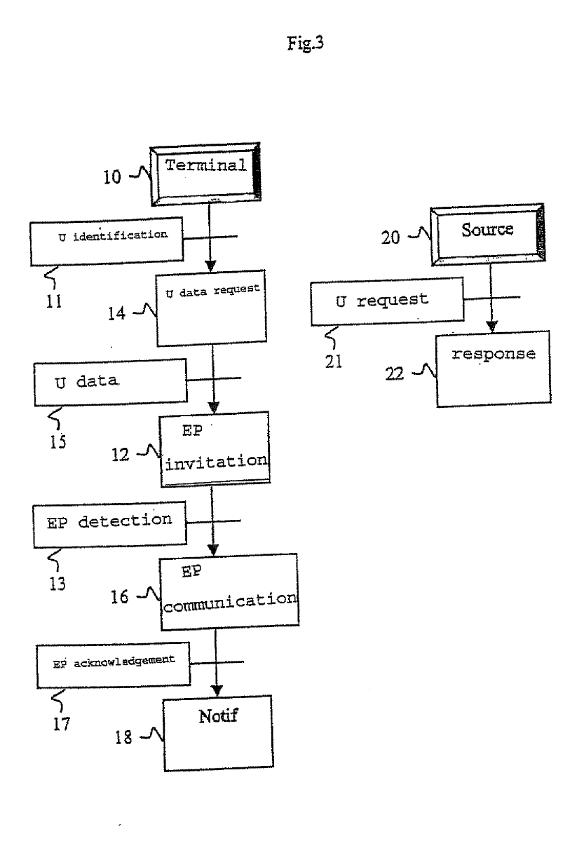

A possible alternative of the method will now be explained in reference to FIG. 3. Only the modifications of the method described above in reference to FIG. 2 are described. For the transitions and steps not involving a modification, reference can be made to the previous explanations, for which the references in the figures designate the same elements.

A validation of the transition 11 when step 10 is activated causes step 10 to be deactivated and step 14 to be activated. This activation, which transmits the request to the source upon identification of the user makes it possible to provide the data more quickly, giving the user a sense of enhanced fluidity.

Step 12 can then be activated by a validation of the transition 15, but can also be activated simultaneously with step 14 by a validation of transition 11, in which case it is understood that step 16 is activated by the variations of transition 13 and transition 15.

The user is able to keep his/her personal equipment in the vicinity of the terminal for the shortest possible time when the request step 14 precedes the invitation step 12. This can reduce fatigue.

Of course, this disclosure is not limited to the embodiments described as examples; thus, it is possible to have other steps than those presented in FIGS. 2 and 3.

Although the present disclosure has been described with reference to one or more examples, workers skilled in the art will recognize that changes may be made in form and detail without departing from the scope of the disclosure and/or the appended claims.

1. Method for saving data reserved for a user with personal equipment, wherein the method comprises:
a step of identification of said user independently from said personal equipment;
a step of detection, by a secure terminal, of said personal equipment in the vicinity of said secure terminal;
a step of short-distance communication of said data between the personal equipment and a secure terminal, implemented in case of positive identification and detection;
a step of saving said reserved data and/or making said data reserved available by distant saving means, via said secure terminal.

2. Method for saving data according to claim 1, wherein the method includes a request step in which the secure terminal obtains said data from an integrated source by a secure end-to-end connection.

3. Method for saving data according to claim 1, wherein the method includes a step of invitation to bring the personal equipment to the secure terminal.

4. Method for saving data according to claim 2, wherein said integrated source is contained in a trusted server.

5. Method for saving data according to claim 2, wherein said integrated source is contained in a smart card.

6. Method for saving data according to claim 1, wherein, in the short-distance communication step, a radiofrequency power is transmitted by the personal equipment.

7. Method for saving data according to claim 2, wherein the method includes:
a request step in which the secure terminal obtains said data from an integrated source by a secure end-to-end connection; and
a step of invitation to bring the personal equipment to the secure terminal, wherein the request step precedes the invitation step.

8. Method for saving data according to claim 2, wherein said integrated source is contained in the personal equipment.

9. Method for saving data according to claim 8, wherein, in the short-distance communication step, a communication power is transmitted by the secure terminal.

10. System for saving data reserved for a user with personal equipment, wherein the system comprises:
a secure terminal arranged to carry out a short-distance communication with the personal equipment, said short-distance communication being determined by a user identification independently of said personal equipment and by a detection of the personal equipment in the vicinity of the secure terminal, said secure terminal being arranged so as to save and/or make available said reserved data.

11. System for saving data according to claim 10, wherein the secure terminal is arranged so as to obtain said data from an integrated source by a secure end-to-end connection.

12. System for saving data according to claim 10, wherein the secure terminal is arranged so as to display a message of invitation to bring the personal equipment to the secure terminal.

13. System for saving data according to claim 11, wherein said integrated source is contained in a trusted server.

14. System for saving data according to claim 11, wherein said integrated source is contained in a smart card.

15. System for saving data according to claim 10, wherein the personal equipment is arranged to transmit a power by radiofrequency so as to carry out the short-distance communication.

16. System for saving data according to claim 11, wherein said integrated source is contained in the personal equipment.

17. System for saving data according to claim 16, wherein the secure terminal is arranged so as to transmit a power by radiofrequency so as to carry out the short-distance communication.

18. Method for saving data according to claim 1, wherein said identification of said user is implemented with a smart card.

19. System for saving data according to claim 11, wherein the secure terminal is arranged so as to allow said identification of said user, independently of said personal equipment, with a smart card.
